(19) United States
(12) Patent Application Publication
(10) Pub. No.: US 2025/0296615 A1
(43) Pub. Date: Sep. 25, 2025

(54) HYGIENIC RECEPTACLE DOLLY

(71) Applicant: Bunzl Distribution USA, LLC, Creve Coeur, MO (US)

(72) Inventors: Galen Soule, Olathe, KS (US); Michael Darter, Kansas City, MO (US); Bryon London, Kansas City, MO (US); Bernard Jeckell, Parkville, MO (US)

(21) Appl. No.: 19/083,986

(22) Filed: Mar. 19, 2025

Related U.S. Application Data
(60) Provisional application No. 63/567,180, filed on Mar. 19, 2024.

(51) Int. Cl. B62B 5/00

(52) U.S. Cl. CPC B62B 5/0093; B62B 2301/04

(57) ABSTRACT

A universal-fit dolly receptacle with a hygienic design, for receptacle sizes between 20 and 55 gallons. This dolly is designed for use in environments that require cleanliness and attention to sanitation. The hygienic dolly includes a smooth first portion design with no points for standing water or bacteria harbor points. The second portion of the dolly comprises fillets that allow for the average human finger to easily wipe down and sterilize the dolly.

### FIELD OF THE INVENTION

The present invention relates to a dolly for a container, receptacle or drum, and, more particularly, to a dolly with improved hygienic properties.

### BACKGROUND OF THE INVENTION

Dollies are widely used in various settings, including residential, commercial, and industrial environments, to facilitate the easy transportation and handling of containers, receptacles, and drums. These dollies typically consist of a platform with wheels or casters that support the weight of the receptacle, allowing for smooth movement across different surfaces. The design of traditional receptacle dollies focuses primarily on durability and ease of use, ensuring that users can efficiently move heavy or bulky waste containers without exerting excessive physical effort.

In settings such as healthcare facilities, food processing plants, and other environments where contamination control is paramount, the hygienic qualities of receptacle dollies become a significant concern. Existing designs often fall short in preventing the accumulation of dirt, germs, and bacteria, which can lead to cross-contamination and the spread of infections. The surfaces of traditional dollies may harbor pathogens due to their material composition and structural design, which are not optimized for easy cleaning or disinfection. Furthermore, the presence of crevices and joints in these designs can complicate thorough sanitation efforts, thereby compromising the overall hygiene standards required in such critical environments. Consequently, there is a pressing need for an improved receptacle dolly that not only fulfills its transport function but also enhances hygienic safety by minimizing potential contamination risks.

### SUMMARY OF THE INVENTION

The dolly of this disclosure is designed for environments where hygiene and sanitation are desired, such as for public health safety in a hospital or laboratory. To make the dolly hygienic, the top side of the dolly is smooth with no valleys or depressions for liquids to stand. Further, one or more holes or cutouts, such as a hole in the middle of the dolly, may allow fluids to drain. The caster wheel housing is closed from the top side, preventing fluids from entering the castor wheel housing. This design greatly reduces areas that are difficult to clean compared to existing dolly designs.

The bottom of this dolly differentiates itself from previous designs by eliminating areas outside of the caster wheel housing that an average human finger cannot efficiently clean. Small, sharp corners have been removed on the bottom design. All edges have a radius to them ranging between 1/16 and ¼ inches that allow for more efficient cleanability. The radiused edges uplift any sharp corners and rounds them, allowing a human finger to clean the surface area more quickly and efficiently. The castor wheel housings are located further out from the center of the dolly, creating a more stable dolly. The castor wheel housings are reduced in size, so their inner diameter is covered by the outside diameter of the caster wheels' top plate, further serving as a barrier for foreign substances.

This application is generally directed to a hygienic receptacle dolly comprising a first portion with a first planar portion. The circumference of this first planar portion defines the peripheral edge of the first portion, which includes a first side wall coupled to the peripheral edge of the first portion. A second portion is coupled to the first side wall and comprises a second planar portion. The circumference of the second planar portion defines the peripheral edge of the second portion, which includes a second side wall coupled to the peripheral edge of the second portion. The first planar portion features a first surface and a bottom surface, with a first plurality of linear ribs coupled to the bottom surface. The lower planar portion also has a first surface and a second surface. It further comprises a plurality of cutouts extending through both the first and second surfaces. The second surface of the second planar portion includes a second plurality of linear ribs, a plurality of rounded ribs, and a plurality of castor wheel housings.

In another aspect, this application is generally directed to a hygienic receptacle dolly comprising an first portion with an first planar portion and an first side wall coupled to the periphery of the first planar portion. A second portion is coupled to the first side wall, featuring a second planar portion and a second side wall coupled to the periphery of the second planar portion. The first planar portion includes a first surface and a second surface, while the second planar portion also has a first surface and a second surface. The second portion further includes a plurality of cutouts extending through the first and second surfaces of the second planar portion. Additionally, the second surface of the second planar portion has coupled to it a plurality of linear ribs, a plurality of rounded ribs, and a plurality of castor wheel housings.

### BRIEF DESCRIPTION OF THE DRAWINGS

FIG. 1 is a perspective view of a hygienic receptacle, in accordance with aspects herein;

FIG. 2 is an additional perspective view of the hygienic receptacle, in accordance with aspects herein;

FIG. 3 is a plan view of the first surface of the hygienic receptacle, in accordance with aspects herein;

FIG. 4 is a plan view of the second surface of the hygienic receptacle, in accordance with aspects herein;

FIG. 5 is side view of the hygienic receptacle, in accordance with aspects herein;

FIG. 6 is an enlarged perspective view of a castor support for the hygienic receptacle, in accordance with aspects herein; and

FIG. 7 is an additional enlarged perspective view of the castor support for the hygienic receptacle, in accordance with aspects herein; and

While the disclosure is susceptible to various modifications and alternative forms, a specific embodiment thereof is shown by way of example in the drawing and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

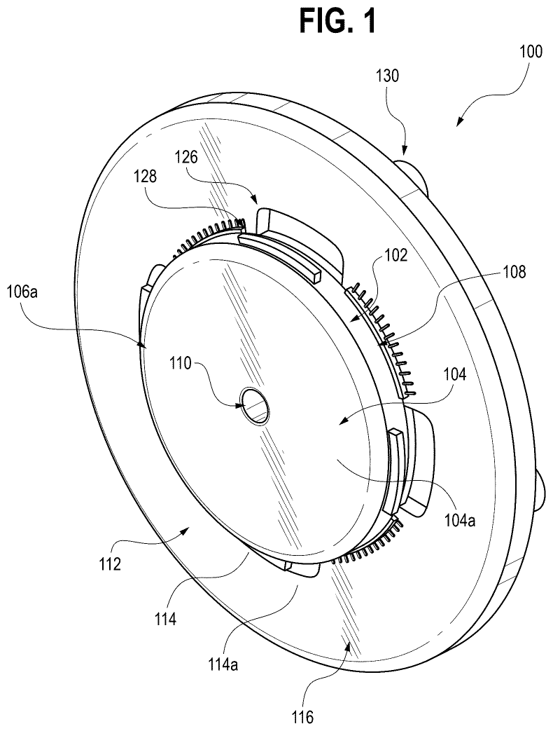

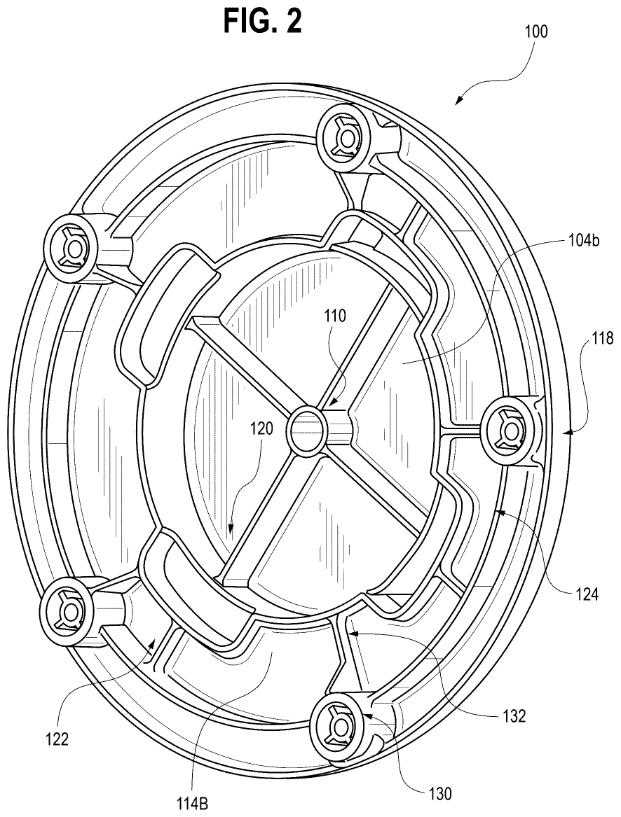

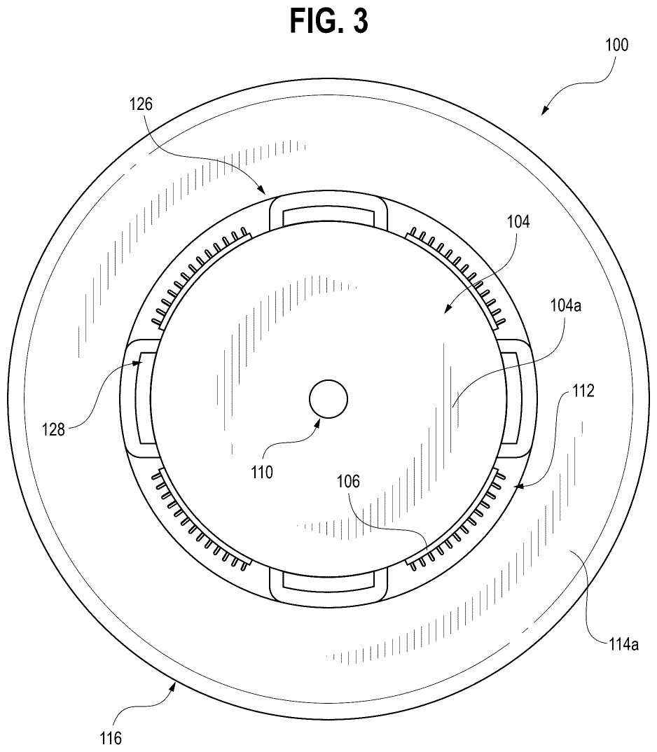

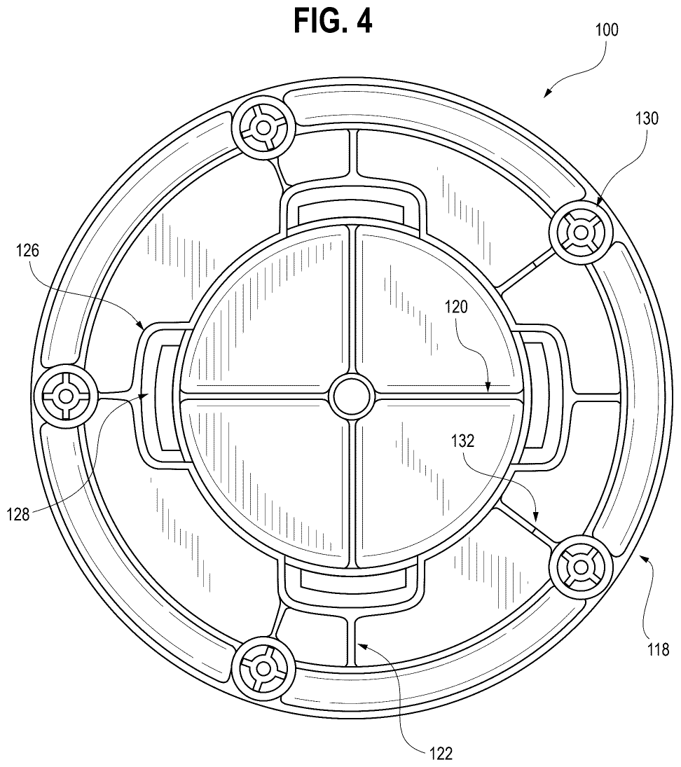

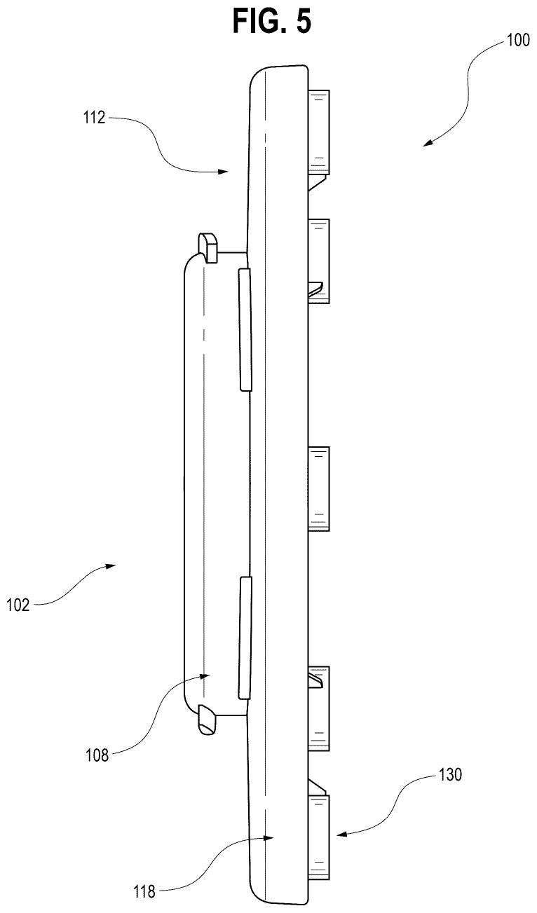

The present invention is generally directed to a hygienic receptacle dolly 100 depicted in corresponding FIGS. 1-7, in accordance with aspects herein. As described herein, the term “hygienic” refers to a design that prioritizes hygiene. In general, a top overall surface of the hygienic receptacle dolly 100 (depicted in FIGS. 1 and 3) is generally smooth which thus helps to reduce potential points for standing water accumulation or bacteria harboring. Furthermore, a bottom overall surface of the dolly (depicted in FIGS. 2 and 4) incorporates filleted edges, which are specifically engineered to allow the average human finger to easily access and wipe down the surface. This facilitates efficient sterilization, ensuring that the dolly can be maintained in a hygienic state with minimal effort. The combination of these design elements underscores the dolly's commitment to maintaining superior hygienic standards.

For example, FIG. 1 depicts a perspective view of a hygienic receptacle dolly 100, in which the hygienic receptacle dolly 100 comprises an first portion 102 and a second portion 112 coupled thereto. As described herein and shown throughout the FIGS., each of the first portion 102 and the second portion 115 further comprises additional components designed to enhance both general functionality and hygiene. When the hygienic receptacle dolly is oriented in a “right side up” configuration, the first portion 102 is positioned superior to the second portion 112, such that the first portion 102 may be referred to hereinafter as the upper portion 102 while the second portion 112 may be referred to hereinafter as the lower portion 112. The hygienic receptacle dolly 100 is sized to hold and mate with a receptacle (not shown) capable of holding between twenty and fifty-file gallon of material, though other sizes are considered to be within the scope of this disclosure. Broadly, the upper portion 102 is sized and designed to mate with a corresponding indentation in the receptacle, and the lower portion 112 is sized and designed to mate with the areas of the receptacle surrounding the indentation.

The upper portion 102 includes a first (or upper) planar portion 104, in which the upper planar portion 104 includes a first (or top) surface 104a (shown in FIGS. 1 and 3) and a second (or bottom) surface 104b (shown in FIGS. 2, 4, 6 and 7). In other words, the first surface 104a and the second surface 104b may be hereinafter referred to as a top surface 104a and a bottom surface 104b, respectively. While the upper planar portion 104 is generally depicted and described herein as being round, other shapes of the upper planar portion 104 are contemplated to be within the scope of this disclosure. For example, the upper planar portion 104 may be any other standard polygonal shape. Furthermore, the upper portion 102 includes a center through hole 110 (shown in FIGS. 1-5) that spans the thickness of the upper planar portion 104 by extending through the top surface 104a and the bottom surface 104b. Additionally, the bottom surface 104b of the upper planar portion 104 comprises a first plurality of linear ribs 120 coupled thereto. Generally, the first plurality of linear ribs 120 intersect in a perpendicular configuration at a central portion of the bottom surface 104b. In accordance with aspects herein, the first plurality of linear ribs may be partially coupled to the center through hole 110, such that the first plurality of linear ribs 120 reinforce the structure of the upper planar portion 104 as well as the structure of the center through hole 110. Furthermore, the location of the first plurality of linear ribs 120 on the bottom surface 104b prevents the buildup of debris and contaminants, as the first plurality of linear ribs 120 does not generally contact the receptacle.

In accordance with aspects herein, the upper portion 102 further comprises a first (or upper) portion peripheral edge 106, which is generally defined as circumscribing of the upper planar portion 104. Additionally, attached to the upper portion peripheral edge 106 is a first (or upper) portion side wall 108, depicted in FIGS. 1, 2 and 5. Generally, the upper portion side wall 108 extends downward (towards the lower portion 112) from the upper portion peripheral edge 106, which in turn forms a perpendicular coupling between the upper portion peripheral edge 106 and the upper portion side wall 108.

The hygienic receptacle dolly 100 further comprises the second portion 112, which includes a second planar portion 114 including a first surface 114a (shown in FIGS. 1 and 3) and a second surface 114b (shown in FIGS. 2, 4, 6 and 7). In accordance with aspects herein, the second portion 112 and the second planar portion 114 may be referred to hereinafter as the bottom portion 112 and the bottom planar portion 114. Additionally, the first surface 114a and the second surface 114b may alternatively be referred to hereinafter as the top surface 114a and the bottom surface 114b, respectively. Generally, the upper portion 102 and the lower portion 112 are coupled together at a location between the lower planar portion 114 and the upper portion side wall 108. In other words, the lower planar portion 114 and the upper portion side wall 108 are coupled together, thereby maintaining structural integrity of the hygienic receptacle dolly 100. The top surface 114a of the lower planar portion 114 is generally formed to be smooth, without any ribs or crevices. By forming the top surface 114a to be smooth, the properties and shaping of the top surface 114a helps to eliminate crevices and joints where bacteria and odors could otherwise accumulate. The absence of such crevices ensures that the dolly can be easily and thoroughly cleaned, further supporting the hygienic function of the hygienic receptacle dolly 100. The smooth surface also facilitates the easy removal of any waste residues, thereby preventing the buildup of organic matter that could contribute to odor issues.

In accordance with aspects herein, the bottom surface 114b of the lower portion 112 includes a second plurality of linear ribs 122 and a plurality of rounded ribs 124, which are most readily viewed at FIGS. 2 and 4 of this application. The second plurality of linear ribs 122 generally continue the same path of the first plurality of linear ribs 120, except that the second plurality of linear ribs 122 are coupled to the bottom surface 114b of the lower portion 112. The bottom surface 114b further comprises a plurality of rounded ribs 124. Each of the second plurality of linear ribs 122 and the plurality of rounded ribs 124 are coupled to the bottom surface 114b, and extend away from the bottom surface 114b in a perpendicular direction.

Each of the plurality of rounded ribs 124 is generally shaped similarly to a lower (or second) portion peripheral edge 116, such that the plurality of rounded ribs 124 is offset from the lower (or second) portion peripheral edge 116 by a distance spanning 1 to 6 inches. Thus, in accordance with aspects herein, each of the second plurality of linear ribs 122 does not extend completely to a lower portion peripheral edge 116, but instead extends to and terminates at the plurality of rounded ribs 124 (see FIGS. 2, 4, 6 and 7).

The upper portion 102 of the hygienic receptacle dolly 100 may comprise a plurality of notches 128 to assist in the mating of the upper portion 102 with a receptacle. In some aspects, the plurality of notches 128 may be coupled to the upper portion side wall 108, and in other aspects, the plurality of notches may be coupled to another location on the upper portion 102. When in a mated configuration, the plurality of notches 128 may provide an additional point of contact by which the hygienic receptacle dolly 100 and the receptacle may contact each other. Many exemplary receptacles may also comprise corresponding female portions for the plurality of notches 128 to mate with, thereby providing additional stability to the receptacle during transportation. Similarly, the lower portion 112 may comprise a plurality of cutouts 126 that correspond to the plurality of notches 128. The plurality of cutouts 126 span the thickness of the lower planar portion 114 by extending from the top surface 114a to the bottom surface 114b. Generally, the plurality of cutouts 126 are spaced on the lower portion 112 axially around the upper portion side wall 108. The center through hole 110 and the plurality of cutouts 126 allow fluid and other contaminates to pass through the hygienic receptacle dolly 100 and fall to the floor, thereby reducing the volume of fluids and contaminates that settle on the hygienic receptacle dolly 100. In accordance with aspects herein, each of the plurality of notches 128 of the upper planar portion 104 is aligned with each of the plurality of cutouts 126 of the lower planar portion 114. And yet, in other aspects, each of the plurality of cutouts 126 may be encompassed by a cutout rib coupled to the bottom surface of the lower planar portion (see FIGS. 2 and 4). In other words, each of the plurality of cutouts 126 may further comprise a rib that encompasses the cutout, and also extends away from the bottom surface 114b of the lower planar portion 114.

Furthermore, the bottom surface 114b includes a plurality of castor wheel housings 130 (depicted in FIGS. 1, 2, 4, 5, 6 and 7) extending from the bottom surface 114b at a perpendicular angle from the bottom surface 114b, such that each of the plurality of castor wheel housings 130 are located adjacent to the lower portion peripheral edge 116. Each of the plurality of castor wheel housings 130 castor is configured to receive axle of a castor wheel assembly (not shown), thereby facilitating movement of the hygienic receptacle dolly 100 across a surface. The positioning of each of the plurality of castor wheel housings 130 toward the lower portion peripheral edge 116 of the lower planar portion 114 provides additional stability for the hygienic receptacle dolly 100 to resist a tipping force. The embodiment of the hygienic receptacle dolly 100 shown in the FIGS. has five castor wheel housings 130, wherein each of the plurality of castor wheel housings 130 is axially spaced from each other at 72 degrees (equally spaced around a circumference of the bottom surface 114b). However, in accordance with aspects herein, it should be understood that the specific number of the plurality of castor wheel housings 130 as shown herein is merely exemplary, and other numbers of castor wheel housings 130 are considered to be within the scope of this disclosure. In the interest of preventing tipping of the hygienic receptacle dolly 100 and thereby the receptacle, however, each of the plurality of castor wheel housings 130 may be spaced at an equal angular dimension from each other.

In accordance with aspects herein, each of the plurality of castor wheel housings 130 comprises an outer housing 134 and a castor support structure 136 located within the outer housing 134. The outer housing 134 is shown having a cylindrical shape but can be a variety of shapes in other embodiments. Furthermore, the outer housing 134 extends downward (perpendicular to the bottom surface 114b) to make it more difficult for fluids and other particulates to enter the castor wheel housings 130. The castor support structure 136 in this embodiment has a crosshair shape that consists of an inner circle that defines the castor axle hole Notably, the each of the plurality of castor wheel housings 130 does not extend through the top surface 114a of the lower planar portion 114 as may be found in existing designs, thereby preventing any fluid or contaminates from entering the castor wheel housings 130 from the top and becoming lodged.

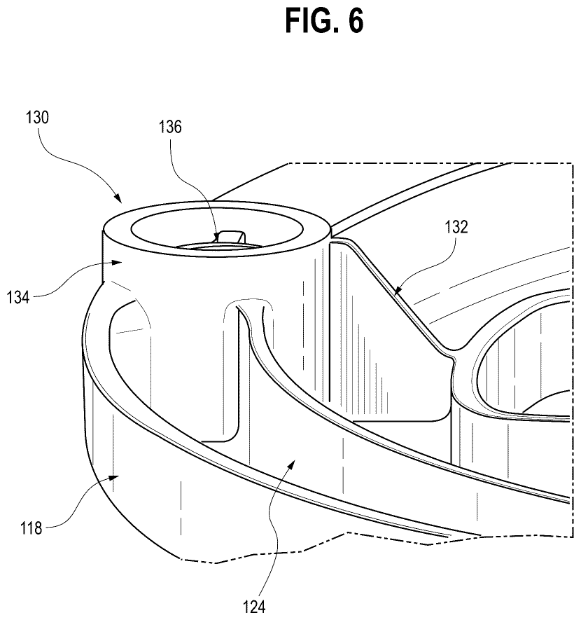

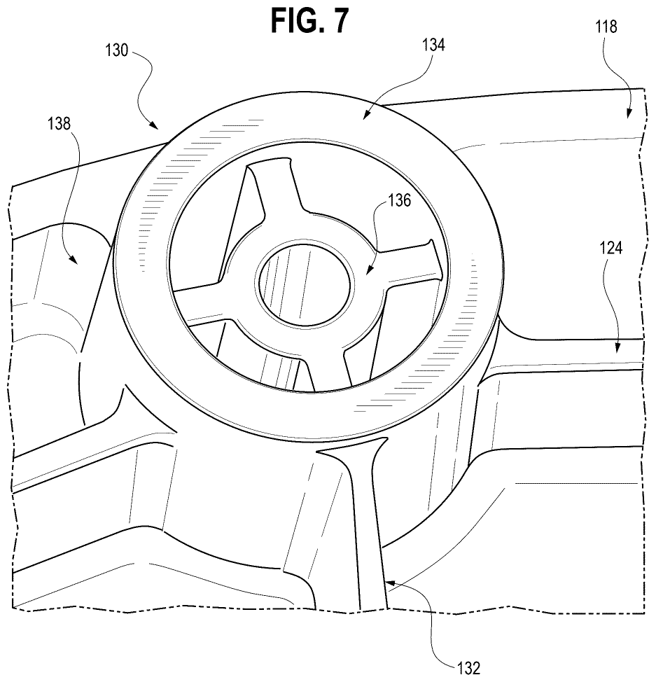

As best shown in FIGS. 6 and 7, each of the plurality of castor wheel housings 130 may comprise a fillet 138 coupled to the lower portion side wall 118. In other words, the fillet 138 may be simultaneously coupled to the castor wheel housings 130 and the lower portion side wall 118. Furthermore, each fillet 138 may comprise a radius measuring between 1/16 and ¼ inches, although sizes outside of the 1/16 and ¼ of each fillet 138 are considered to be within the scope of this disclosure. The fillets 138 depicted in FIGS. 6 and 7 are merely shown at exemplary locations, but may also be applied to any intersection of two components of the dolly 100. For example, where the first plurality of linear ribs 120 intersects the plurality of rounded ribs 124, the fillet 138 may also be present. Generally, the presence of the fillet 138 allows for easiest cleaning and care of the dolly 100, as a human finger more closely resembles a rounded surface than a sharp corner.

Furthermore, each of the plurality of castor wheel housings 130 comprises a castor rib 132 extending therefrom (as best shown in FIGS. 6 and 7). In other words, each castor rib 132 is partially coupled to a respective castor wheel housings 130. Additionally, in some aspects, each castor rib 132 is depicted as having a first end of the castor rib coupled to a respective castor wheel housings 130, and a second end of the castor rib is coupled to a respective cutout 126. However, the second end of the castor rib 132 does not necessarily need to be coupled to a respective cutout, but instead may be coupled to another portion of the bottom surface of the hygienic receptacle dolly 100. For example, in FIG. 2, the castor rib 132 is depicted as partially coupled to a respective cutout 126, and some of the castor ribs are coupled to the upper portion side wall 108. As additionally shown in FIGS. 6 and 7, the castor rib 132 may be tapered from a first end to a second end. The taper of the castor rib 132 may be linear or nonlinear, and the exact shaping of the taper may be modified based on structural optimization tests. Alternatively, the castor rib 132 may comprise both a constant height section and a tapered height section.

From the foregoing, it will be seen that this invention is one well adapted to attain all the ends and objects hereinabove set forth together with other advantages which are inherent to the structure and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A hygienic receptacle dolly comprising:
an first portion having an first planar portion, such that a circumference of the first planar portion defines a peripheral edge of the first portion, and wherein the first portion includes a first side wall coupled to the peripheral edge of the first portion;
a second portion coupled to the first side wall, wherein the second portion comprises a second planar portion, such that a circumference of the second planar portion defines a peripheral edge of second lower portion, and wherein the second portion includes a second side wall coupled to the peripheral edge of the second portion;
wherein the first planar portion of the first portion comprises a first surface and a second surface opposite the first surface, and wherein the second surface of the first planar portion comprises a first plurality of linear ribs coupled thereto; and
wherein the second planar portion of the second portion comprises a first surface and a second surface opposite the first surface, wherein:
the second portion further comprises a plurality of cutouts extending through the first surface and the second surface of the second planar portion;
the second surface of the second planar portion comprises a second plurality of linear ribs, a plurality of rounded ribs, and a plurality of castor wheel housings.

2. The hygienic receptacle dolly of claim 1, wherein the first portion further comprises a plurality of notches.

3. The hygienic receptacle dolly of claim 2, wherein each of the plurality of notches of the first portion is aligned with each of the plurality of cutouts of the second portion.

4. The hygienic receptacle dolly of claim 1, further comprising a through hole extending through the first surface and the second surface of the first portion.

5. The hygienic receptacle dolly of claim 1, wherein one or more cutouts extend through the second portion.

6. The hygienic receptacle dolly of claim 1, wherein each of the plurality of castor wheel housings comprises a fillet coupled to the lower side wall, and wherein each fillet has a radius between 1/16 and ¼ inches.

7. The hygienic receptacle dolly of claim 1, wherein the first plurality of linear ribs of the upper portion extend linearly from a central point of the first portion.

8. The hygienic receptacle dolly of claim 1, wherein a portion of the plurality of castor wheel housings is located at the peripheral edge of the second portion.

9. The hygienic receptacle dolly of claim 1, wherein each of the plurality of castor wheel housings comprises a castor rib extending therefrom.

10. The hygienic receptacle dolly of claim 9, wherein each of the castor ribs comprises a tapered height section.

11. A hygienic receptacle dolly comprising:
a first portion having an first planar portion and an first side wall coupled to a periphery of the first planar portion;
a second portion coupled to the first side wall, the second portion comprising a second planar portion and a second side wall coupled to a periphery of the second planar portion;
wherein the first planar portion comprises a first surface and a second surface, and wherein second planar portion comprises a first surface and a second surface;
wherein the second surface of the first planar portion comprises a first plurality of ribs coupled thereto;
wherein the second portion further comprises a plurality of cutouts extending from through the first surface and the second surface of the second planar portion; and
wherein the second surface of the second planar portion has coupled thereto: a plurality of linear ribs, a plurality of rounded ribs, and a plurality of castor wheel housings.

12. The hygienic receptacle dolly of claim 11, wherein the first portion further comprises a plurality of notches.

13. The hygienic receptacle dolly of claim 12, wherein each of the plurality of notches of the first portion is aligned with each of the plurality of cutouts of the second portion.

14. The hygienic receptacle dolly of claim 11, further comprising a through hole extending through the first surface and the second surface of the first portion.

15. The hygienic receptacle dolly of claim 11, wherein each of the plurality of cutouts is encompassed by a cutout rib coupled to the second surface of the second planar portion.

16. The hygienic receptacle dolly of claim 11, wherein each of the plurality of castor wheel housings comprises a fillet coupled to the second side wall, and wherein each fillet has a radius between 1/16 and ¼ inches.

17. The hygienic receptacle dolly of claim 11, wherein the plurality of linear ribs of the first portion extend linearly from a central point of the first portion.

18. The hygienic receptacle dolly of claim 11, wherein a portion of the plurality of castor wheel housings is located at second side wall of the second portion.

19. The hygienic receptacle dolly of claim 11, wherein each of the plurality of castor wheel housings comprises a castor rib extending therefrom.

20. The hygienic receptacle dolly of claim 19, wherein each of the castor ribs comprises a constant height section and a tapered height section.
